(19) United States
(12) Patent Application Publication
(10) Pub. No.: US 2024/0373414 A1
(43) Pub. Date: Nov. 7, 2024

(54) SYSTEM AND METHOD OF MAPPING BETWEEN DIFFERENT TYPES OF BANDWIDTH PARTS

(71) Applicant: ZTE CORPORATION, Shenzhen (CN)

(72) Inventors: Feng XIE, Shenzhen (CN); Hanchao LIU, Shenzhen (CN); Fei WANG, Shenzhen (CN); Yan XUE, Shenzhen (CN)

(73) Assignee: ZTE CORPORATION, Shenzhen (CN)

(21) Appl. No.: 18/775,803

(22) Filed: Jul. 17, 2024

Related U.S. Application Data
(63) Continuation of application No. PCT/CN2022/085434, filed on Apr. 7, 2022.

(51) Int. Cl. H04W 72/0457; H04W 72/0453; H04W 72/12

(52) U.S. Cl. CPC H04W 72/0457; H04W 72/0453; H04W 72/12

(57) ABSTRACT

Embodiments of a system, device and method for mapping between different types of BWPs are disclosed. In some aspects, a wireless communication method includes receiving, by a wireless communication device from a wireless communication node, radio configuration information that includes a configuration of a second type bandwidth part (BWP), and a correspondence between the second type BWP and a plurality of BWPs. In some aspects, the wireless communication method includes allocating, by the wireless communication device, based on the radio configuration information, a plurality of resources for transmission or reception.

### CROSS-REFERENCE TO RELATED APPLICATION

This application claims the benefit of priority under 35 U.S.C. § 120 as a continuation of International Application No. PCT/CN2022/085434 filed on Apr. 7, 2022, entitled “SYSTEM AND METHOD OF MAPPING BETWEEN DIFFERENT TYPES OF BANDWIDTH PARTS”, the content of which is incorporated herein by reference in its entirety.

### TECHNICAL FIELD

The disclosure relates generally to wireless communications and, more particularly, to systems and methods for mapping between different types of bandwidth parts for transmission or reception resource allocation.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices, and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

Embodiments of a system, device, and method for mapping between different types of BWPs are disclosed. In some aspects, a wireless communication method includes receiving, by a wireless communication device from a wireless communication node, radio configuration information that includes a configuration of a second type bandwidth part (BWP), and a correspondence between the second type BWP and a plurality of BWPs. In some aspects, the wireless communication method includes allocating, by the wireless communication device, based on the radio configuration information, a plurality of resources for transmission or reception.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some embodiments, the wireless communication device receives scheduling information that includes frequency resource information based on the second type BWP and the wireless communication device allocates frequency resources on the plurality of BWPs for data transmission or reception.

In some aspects, a wireless communication method includes transmitting, by a wireless communication node to a wireless communication device, radio configuration information that includes a configuration of a second type bandwidth part (BWP), and a correspondence between the second type BWP and a plurality of BWPs. In some aspects, the wireless communication device allocates, based on the radio configuration information, a plurality of resources for transmission or reception.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some aspects, the wireless communication node transmits scheduling information that includes frequency resource information based on the second type BWP.

In some aspects, a wireless communication apparatus includes at least one processor and a memory. In some aspects, the memory includes instructions. In some aspects, the at least one processor executes the instructions to receive, from a wireless communication node, radio configuration information that includes a configuration of a second type bandwidth part (BWP), and a correspondence between the second type BWP and a plurality of BWPs. In some aspects, the at least one processor executes the instructions to allocate, based on the radio configuration information, a plurality of resources for transmission or reception of a wireless communication device in communication with the wireless communication node.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some embodiments, the wireless communication device receives scheduling information that includes frequency resource information based on the second type BWP and the wireless communication device allocates frequency resources on the plurality of BWPs for data transmission or reception.

In some aspects, a wireless communication apparatus includes at least one processor and a memory. In some aspects, the memory includes instructions. In some aspects, the at least one processor executes the instructions to transmit, to a wireless communication device, radio configuration information that includes a configuration of a second type bandwidth part (BWP), and a correspondence between the second type BWP and a plurality of BWPs. In some aspects, the wireless communication device allocates, based on the radio configuration information, a plurality of resources for transmission or reception.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some aspects, the wireless communication node transmits scheduling information that includes frequency resource information based on the second type BWP.

In some aspects, a wireless communication apparatus comprising at least one processor and a memory, wherein the at least one processor is configured to read code from the memory and implement the method recited in any of the above embodiments.

In some aspects, a computer program product comprising a computer-readable program medium code stored thereupon, the code, when executed by at least one processor, causing the at least one processor to implement the method recited in any of the above embodiments.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3A is a schematic diagram of carrier aggregation, in accordance with some embodiments.

FIG. 3B is a schematic diagram of a second type BWP, in accordance with some embodiments of the present disclosure.

FIG. 4 is a schematic diagram of a second type BWP corresponding to two BWPs, and these two BWPs corresponding to two carriers, in accordance with some embodiments of the present disclosure.

FIG. 5 is a flowchart of the processing of UE side of the method, in accordance with some embodiments of the present disclosure.

FIG. 6 is a schematic diagram of a second type BWP that is associated with a scheduler or a scheduling entity, in accordance with some embodiments of the present disclosure.

FIG. 7 is a flowchart of scheduling processing performed by UE based on the second type BWP, in accordance with some embodiments of the present disclosure.

FIG. 8 illustrates a method for mapping between different types of BWP, in accordance with some embodiments of the present disclosure.

FIG. 9 illustrates a method for mapping between different types of BWP, in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

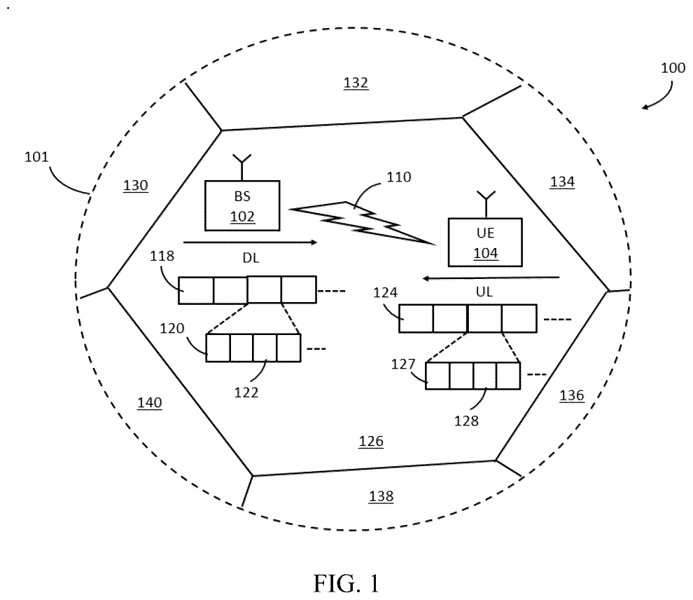

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

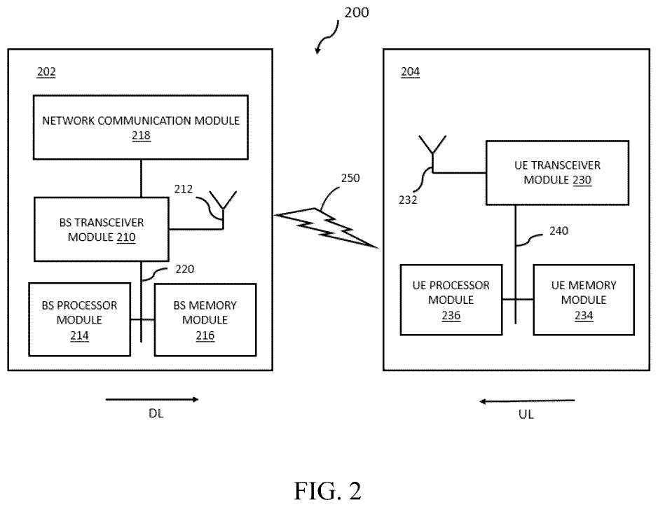

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Mapping Between Different Types of BWP

Carrier aggregation (CA) can be used to deal with fusion of multi-spectrum resources with lower scheduling efficiency. The present disclosure propose embodiments of a system and method of higher efficient scheduling for the fusion of multi-spectrum resources.

The wireless spectrum can be used for communication coverage of mobile networks. Many factors, such as different radio spectrum policies in different countries, market oriented radio spectrum trading, spectrum resource reallocation in previous generation mobile networks (2G and 3G networks), may lead to fragmentation of the current global spectrum resources. Especially in the low frequency, it may be difficult to find continuous large-bandwidth spectrum resources. With the acceleration of 5G commercial use and the emergence of new 6G services, new scenarios, and new applications, it may be necessary to improve use efficiency of spectrum, especially for fragmented spectrum. The efficient use of fragmented spectrum may greatly alleviate the shortage of global spectrum resources.

Carrier aggregation (CA) may be used to fuse multiple spectral resources to improve spectrum resources use efficiency. However, carrier aggregation has some shortcomings. Each carrier corresponds to a cellular cell, which means CA can be equivalent to the aggregation of multiple cellular cells. Each carrier (cell) may be associated with a scheduling processing, and terminal (UE) may need to perform scheduling processing independently for each carrier and the scheduling processing cross the carriers in CA may be same or similar, which may reduce scheduling efficiency. If the number of aggregated carriers will be larger, the scheduling efficiency will become lower. Since a carrier is associated with one or more BWPs, scheduling processing may be based on a BWP for each carrier in CA. It may be very low efficient for terminal (UE) to perform scheduling processing based on a plurality of BWPs for a plurality of carriers in CA.

In some embodiments, a second (e.g., novel, new, aggregation, etc.) type of bandwidth part (BWP) corresponds to a plurality of BWPs, and these BWPs correspond to a plurality of carriers. In some implementations, the frequency domain resources of the second type BWP are mapped to the frequency domain resources of the plurality of BWPs, a part of the frequency domain resources of the second type BWP is mapped to frequency domain resources of a BWP, and another part of the frequency domain resources of the second type BWP is mapped frequency domain resources of another BWP. In some aspects, the bandwidth of the second type BWP is equal to the sum of the bandwidths of the plurality of BWPs. In some embodiments, scheduling on a plurality of BWPs for fusion of multi-spectrum may be based on a second type BWP which corresponds to the plurality of BWPs. It may be higher efficient for terminal (UE) to perform scheduling processing for fusion of multi-spectrum as above-mentioned method.

In some embodiments, a user equipment (UE, e.g., the UE 104, the UE 204, a mobile device, a wireless communication device, a terminal, etc.) is based on the second type BWP for scheduling processing of data transmission or reception. In some implementations, the data on the second type BWP and the frequency domain resources assigned to data in the second type BWP, including but not limited to resource blocks (RBs), resource units (RE), control channel elements (CCE), are mapped to a plurality of BWPs. The UE can be based on BWP for physical layer processing, including: transmitting and receiving data and signals.

In some aspects, a BWP is a subset of successive blocks of common resources (CRBs) that correspond to a specific subcarrier spacing on a given carrier. In some embodiments, the frequency domain start and the number of RBs contained in the BWP need to be met, respectively:

$${N}_{grid , x}^{start , μ} \leq {N}_{BWP , x}^{start , μ} < {N}_{grid , x}^{start , μ} + {N}_{grid , x}^{size , μ} , \\ {N}_{grid , x}^{start , μ} < {N}_{BWP , x}^{start , μ} + {N}_{BWP , x}^{size , μ} \leq {N}_{BWP , x}^{start , μ} + {N}_{grid , x}^{size , μ} ,$$

where N_{grid, x}^{start, μ} represents the start of the frequency domain of the resource grid, N_{grid, x}^{size, μ} represents the width of the frequency domain of the resource grid, N_{BWP, i}^{start, μ} represents the start of the frequency domain of the i-th BWP on the carrier, N_{BWP, i}^{size, μ} represents the width of the frequency domain of the i-th BWP on the carrier, represents the subcarrier spacing coefficient, and x is used to indicate the identifier of the uplink resource grid or the downlink resource grid.

For a downlink carrier, the UE configures up to 4 downlink BWPs, and activates up to one BWP in a given time. In some aspects, the UE is configured to not receive the physical downlink shared channel (PDSCH), physical downlink control channel (PDCCH), or channel state information reference signal (CSI-RS) (except radio resource management (RRM)) in the frequency domain outside the BWP.

For an uplink carrier, the UE configures up to 4 uplink BWPs, and activates up to one BWP in a given time. When the UE is configured with a supplementary uplink (SUL), the UE can additionally configure up to 4 uplink BWPs on the SUL carrier, and can activate up to one BWP in a given time. In some implementations, the UE does not transmit the physical uplink shared channel (PUSCH) or physical uplink control channel (PUCCH) in the frequency domain outside the activated BWP. In some aspects, for an activated carrier, the UE does not send the sounding reference signal (SRS) in the frequency domain outside the activated BWP.

In some aspects, for each carrier and each sub-carrier spacing, in the uplink or downlink transmission direction, a resource grid is defined respectively, and the resource grid includes a series of continuous subcarriers and a series of continuous time-domain OFDM symbols. The carrierBandwidth in the radio resource control RRC information element IE SCS-SpecificCarrier configures the bandwidth of the resource grid, and the offsetToCarrier in the Radio resource control information element (RRC IE) SCS-SpecificCarrier configures the frequency domain start position of the resource grid. In addition, the txDirectCurrentLocation in the RRC IE UplinkTxDirectCurrentBWP and the txDirectCurrentLocation in the SCS-SpecificCarrier respectively configure the frequency domain locations of the upstream and downstream DC subcarriers of the resource grid of the resource grid.

The RRC IE SCS-SpecificCarrier provides configuration parameters related to the carrier bandwidth at the subcarrier spacing level, and the configuration parameters determine the frequency domain position of the carrier bandwidth (refer to PointA) and the width of the frequency domain range of the carrier bandwidth. For the subcarrier spacing corresponding to each BWP, an RRC IE SCS-SpecificCarrier is configured.

Carrier aggregation (CA) aggregate multiple carriers for larger bandwidth of frequency domain resource, to improve UE throughput. However, carrier aggregation has some shortcomings. Each carrier may be associated with a scheduling processing. Terminal (UE) needs to perform scheduling processing of data transmission or reception independently for each carrier. In some scenarios, the scheduling processing cross the carriers may be repeated, which increases the scheduling overhead of the terminal (UE) and reduce scheduling efficiency. Since the scheduling processing are based on one or more BWPs for each carrier in CA, it may be very low efficient for terminal (UE) to perform scheduling processing based on a plurality of BWPs in CA.

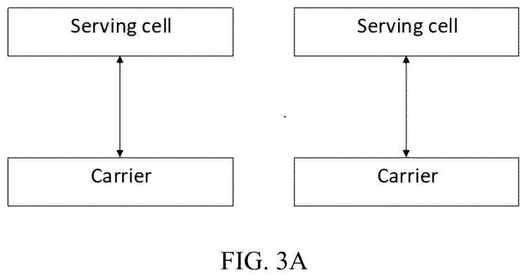

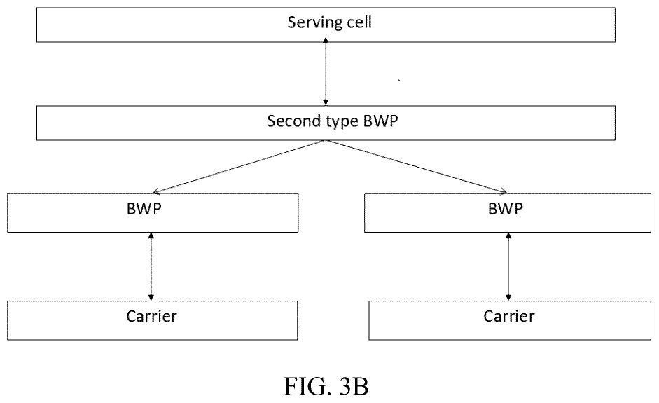

It may be necessary for UE to perform scheduling processing, including frequency domain resource allocation for data transmission or reception on each of the carriers, based on the bandwidth and frequency position of each of the carriers. In addition, it may be necessary for UE to receive scheduling indication information for each of the carriers. Although cross-carrier scheduling is helpful for CA to save scheduling resource, when the number of carriers is large, the scheduling resource overhead is still too large and scheduling efficiency is still too low. As mentioned above, the scheduling processing for the carriers in CA may be the same or similar, which may cause UE to perform a large number of repeated processes. It may consume (e.g., excessively consume, waste, etc.) the scheduling and processing resources of terminal, resulting in low scheduling efficiency. FIG. 3A is a schematic diagram of carrier aggregation, in accordance with some embodiments. Compared with independent scheduling processing for each carrier in CA, one scheduling processing for multiple carriers in fusion of multi-spectrum resources may improve higher scheduling efficiency.

In the present disclosure, disclosed herein is a second type BWP. The second type BWP, which can also be called a virtual BWP, corresponds to a collection of continuous resource blocks (RB) with a specific subcarrier spacing, and corresponds a plurality of carriers or a plurality of BWPs, and corresponds to the scheduling processing of data transmission and reception. Within the scope of the second type BWP, UE can perform the scheduling processing indicated by the scheduling information. In some embodiments of UE performing scheduling processing, UE allocates frequency domain resources (RB resources) for data within the frequency domain of the second type BWP, and then the data and the frequency domain resources on the second type BWP are mapped to a plurality of BWPs for transmission. These BWPs may be on a plurality of carriers or correspond a plurality of carriers. In some embodiments of UE performing scheduling processing, according to frequency domain resources (RB resources) on the second type BWP indicated by the scheduling information, and the mapping between the second type BWP and a plurality of BWPs that may be on a plurality of carriers or correspond a plurality of carriers, UE, based on the frequency domain resources of the BWPs mapped from indicated frequency domain resources of the second type BWP, receives data on the BWPs and maps the data to the second type BWP. Then UE may perform subsequent processing of the data on the second type BWP.

Multiple BWPs (carriers) can be mapped to a continuous frequency domain resource (the second type BWP). In some embodiments, UE only needs to perform scheduling processing or resource allocation based on this continuous frequency domain resource, which simplifies repetitive processing, reduces processing overhead and improve scheduling efficiency. Some embodiments of the present disclosure may save the processing overhead of a base station (BS, e.g., the BS 102, the BS 202, a next generation NodeB (gNB), an evolved NodeB (eNB), a wireless communication node, a cell tower, a 3GPP radio access device, a non-3GPP radio access device, etc.) as well. In some embodiments, multiple BWPs correspond to a second type BWP (e.g., multiple carriers correspond to multiple BWPs, multiple BWPs correspond to one second type BWP, one second type BWP corresponds to one cell), which reduces the workload of cell management as well. FIG. 3B is a schematic diagram of an embodiment of the second type BWP in the present disclosure.

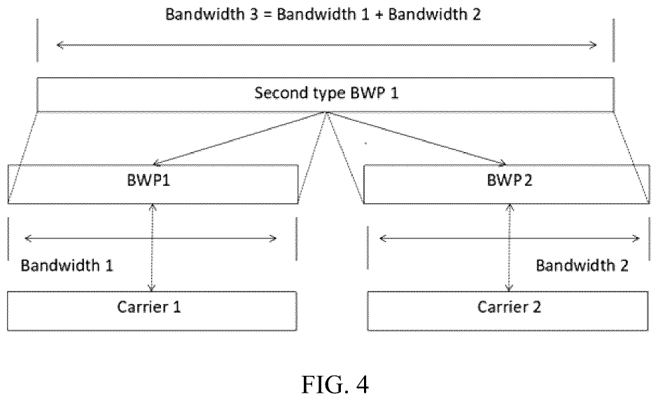

One embodiment provides a second type BWP corresponding to multiple BWPs, each BWP corresponds to one or more carriers. FIG. 4 is a schematic diagram of a second type BWP corresponding to two BWPs, and these two BWPs corresponding to two carriers. In the embodiment of FIG. 4, the second type BWP 1 corresponds to (e.g., maps to, translates to, points to, associates with, etc.) BWP1 and BWP2. In the embodiment of FIG. 4, bandwidth 3 (the bandwidth of the second type BWP 1) is equal to a sum of bandwidth 1 (the bandwidth of BWP1) and bandwidth 2 (the bandwidth of BWP2). In the embodiment of FIG. 4, BWP1 corresponds to carrier 1, and BWP2 corresponds to carrier 2.

In some embodiments, a second type BWP corresponds to a subcarrier spacing (SCS), and the subcarrier spacing configuration can be 0, 1, 2, . . . , respectively representing multiples of the reference subcarrier spacing which can include, but is not limited to, 15 KHz. In some embodiments, BWP corresponds to a subcarrier spacing (SCS). The subcarrier spacing configuration μ can be 0, 1, 2, . . . , respectively representing multiples of the reference subcarrier spacing. The reference subcarrier spacing can include, but is not limited to, 15 KHz.

The second type BWP can be associated with the control processing of receiving and transmitting data, such as scheduling processing, or radio resource configuration. The second type BWP can be associated with a medium access control (MAC) entity, a scheduler, a radio resource control (RRC) entity, or a radio resource management entity.

In some embodiments, the second type BWP is associated with physical resource configuration which includes physical channel configuration and physical reference signal configuration. The physical channel configuration includes the configuration of physical uplink shared channel or physical downlink shared channel (PUSCH or PDSCH), the configuration of physical uplink control channel or physical downlink control channel (PUCCH or PDCCH), and the configuration of the physical random access channel (PRACH). Among them, the configuration of physical uplink shared channel or physical downlink shared channel includes, but is not limited to, time domain resource allocation configuration, frequency domain resource allocation type configuration, modulation and coding scheme table configuration, and uplink power control related configuration. The configuration of physical uplink control channel or physical downlink control channel includes but is not limited to: downlink control resource set (CORESET) configuration, searchspace configuration, PUCCH resource set configuration, scheduling request configuration, and downlink feedback timing sequence configuration. The physical reference signal configuration includes but is not limited to: demodulation reference signal (DMRS) configuration, channel state information (CSI) measurement configuration, sounding reference signal (SRS) configuration, and phase tracking reference signal (PTRS) configuration.

The second type BWP may include one physical channel configuration for one or more of the same type of physical channels, including one or more PUSCH/PDSCH, one or more PUCCH/PDCCH, and one or more PRACH. The second type BWP may include one physical reference signal configuration for one or more of the same type of physical reference signals, including one or more DMRS, one or more CSI measurement, one or more SRS, and one or more PTRS.

One BWP may correspond to one or more carrier, and one carrier may correspond to one or more BWP.

In one embodiment, one second type BWP corresponds to a plurality of BWPs, and these BWPs correspond to a plurality of carriers. A second type BWP may be mapped to a plurality of BWPs. A part of collection of RBs of the second type BWP may be mapped to collection of RBs of one BWP. Another part of collection of RBs of the second type BWP may be mapped to collection of RBs of another BWP. The bandwidth of the second type BWP may be equal to the sum of the bandwidths of corresponding a plurality of BWPs.

In one example, a second type BWP corresponds to two BWPs, and the bandwidths of the two BWPs are 60 MHz and 40 MHz, respectively. The second type BWP can be mapped to these two BWPs. The bandwidth of the second type BWP can be equal to the sum of the bandwidth of the two BWPs, 60 MHz+40 MHz=100 MHz. 60% of the frequency domain resource of the second type BWP can be mapped to a BWP with a bandwidth of 60 MHz, and 40% of the frequency domain resource of the second type BWP can be mapped to a BWP with a bandwidth of 40 MHz.

In some embodiments, the UE performs the scheduling processing indicated by the scheduling information within the second type BWP, including: allocating frequency domain resource blocks (RB) for the PUSCH(s) or determining frequency domain resource blocks (RB) for the PDSCH(s). The allocated RB resources for PUSCH(s) on the second type BWP can be mapped to the RB resources of the corresponding BWP for PUSCH(s) transmission. According to RB resources for PDSCH(s) on the second type BWP indicated by the scheduling information, and mapping between the second type BWP and the BWPs, UE can receive the PDSCH(s) on the BWPs and map it (them) to the second type BWP. The subsequent processing about PDSCH(s) can be performed based on the second type BWP.

For communication nodes such as base stations or terminals, the mapping between the second type BWP and BWP can be implemented in a module (e.g., processor, component, system on a chip, etc.) responsible for baseband processing. The baseband processing can include but is not limited to: radio resource management, radio resource allocation, or scheduling. In the module, a second type BWP can be mapped to a plurality of BWPs, and data and signal on the second type BWP can be mapped to the corresponding BWPs.

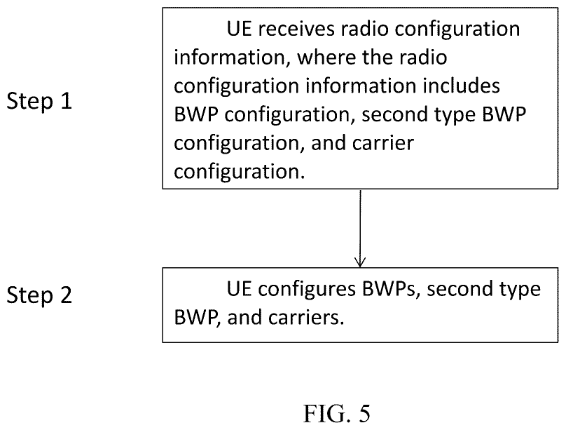

FIG. 5 is a flowchart of the processing of UE side of the method of the present disclosure in one embodiment.

Step 1: UE receives configuration information, where the configuration information includes BWP configuration, second type BWP configuration, and carrier configuration. In some embodiments, the configuration information includes correspondence between second type BWP and BWP. The correspondence may be in the second type BWP configuration information, in the BWP configuration information, or separately indicated.

In some implementations, the correspondence between second type BWP and BWP in the configuration information includes that one second type BWP corresponds to a plurality of BWPs. In some aspects, these BWPs may correspond to a plurality of carriers. In some aspects, one or more second type BWPs may be configured according to the second type BWP configuration included in the configuration information. In some aspects, multiple BWPs may be configured according to the BWP configuration included in the configuration information. In some aspects, multiple carriers may be configured according to the carrier configuration included in the configuration information. In some embodiments, the bandwidth of a second type BWP is equal to the sum of the bandwidths of a plurality of BWPs:

$${BW}_{STbwp} = Σ {BW}_{bwp , i} ,$$

where, BW_{STbwp} represents the bandwidth of the second type BWP, and BW_{bwp,i} represents the bandwidth of the i-th BWP.

In some implementations, the correspondence between second type BWP and BWP includes a correspondence between the second type BWP and a plurality of BWPs with the same subcarrier spacing. In some embodiments, the correspondence between second type BWP and BWP includes a correspondence between the second type BWP and a plurality of BWPs with different subcarrier spacings.

In the prior art, up to four BWPs can be configured in one direction (uplink or downlink) of the serving cell configuration. The configuration of BWP can include but is not limited to the context included in Radio Resource Control Information Element (RRC IE) BWP:

BWP:: = SEQUENCE {
locationAndBandwidth,
subcarrierSpacing,
...
},

where locationAndBandwidth represents the frequency domain location and bandwidth of BWP; subcarrierSpacing represents the subcarrier spacing of BWP.

In the prior art, in one direction (uplink or downlink) of the serving cell configuration, multiple carriers with different subcarrier spacings can be configured, but, only one carrier can be configured for each subcarrier spacing.

The configuration of the carrier can include the context included in Radio Resource Control Information Element (RRC IE) SCS-SpecificCarrier:

SCS-SpecificCarrier :: = SEQUENCE {
offsetToCarrier,
subcarrierSpacing,
carrierBandwidth,
...
},

where SCS-SpecificCarrier represents the configuration of subcarrier spacing specific carrier; offsetToCarrier represents the frequency domain offset between the carrier and the frequency domain reference point PointA, thereby determining the frequency domain position of the carrier; subcarrierSpacing represents the subcarrier spacing of the carrier; and carrierBandwidth represents the bandwidth of the carrier.

In some embodiments of the present disclosure, the configuration of the second type BWP is included in the cell configuration, and the cell configuration may include a serving cell configuration (same or similar to the configuration information indicated by ServingCellConfig 1E) and a serving cell configuration common part (same or similar to the configuration information indicated by ServingCellConfigCommon IE). The second type BWP configuration can include the second type BWP index, subcarrier spacing, and bandwidth.

The representation of correspondence between second type BWP and BWP can include that: (a) second type BWP configuration includes index of BWP; or, (b) BWP configuration includes index of second type BWP; or, (c) a single configuration information contains second type BWP index and BWP index.

In some embodiments, the carrier configuration list is included in the subcarrier spacing specific carrier configuration (same or similar to the configuration information indicated by SCS-SpecificCarrier IE). The carrier configuration list can contain one or more carrier configurations. That is, the carrier configuration list can contain one or more carriers with the same subcarrier spacing. Carrier configuration can include a carrier index, a frequency domain position (a lowest frequency point, or a center frequency point, or an offset relative to the reference point), a bandwidth, and a subcarrier spacing.

The representation of correspondence between carrier and BWP can include that: (a) carrier configuration includes index of BWP; or, (b) BWP configuration contains index of carrier, or, (c) a single configuration information includes carrier index and BWP index.

In the present embodiment, representations of the configuration of carrier, the configuration of second type BWP, the configuration of correspondence between second type BWP and BWP, and the correspondence between carrier and BWP by Radio Resource Control Information Element (RRC IE) includes at least one of the following methods:

Method 1: the first RRC IE represents the configuration information of the second type BWP, including the second type BWP index, a bandwidth, and a corresponding BWP index list. The second RRC IE represents BWP configuration information, including a BWP index, a bandwidth, and a corresponding carrier index. The third RRC IE represents carrier configuration information, including a carrier index, a frequency domain position, and a bandwidth. The method can be shown with the pseudo-code that follows.

Second type BWP configuration:: = SEQUENCE {

| | |
|---|---|
| Second type BWP index | INTEGER (1..max number of second |
| | type BWP index), |

| | |
|---|---|
| Bandwidth | INTEGER (1..max number of RB), |

| | |
|---|---|
| Corresponding BWP index list | SEQUENCE (SIZE (1..max number |

of BWP index)) OF BWP index,
...
},
BWP configuration:: = SEQUENCE {

| | |
|---|---|
| BWP index | INTEGER (1..max number of BWP index), |
| Bandwidth | INTEGER (1..max number of RB), |

| | |
|---|---|
| Corresponding carrier index | INTEGER (1..max number of |
| | carrier index), |

...
},
Carrier configuration:: = SEQUENCE {

| | |
|---|---|
| Carrier index | INTEGER (1..max number of carrier index), |
| Bandwidth | INTEGER (1..max number of RB), |

| | |
|---|---|
| Frequency domain position | INTEGER (1...N), |

...
}

Second type BWP configuration, BWP configuration, and Carrier configuration are not limited to the above. Frequency domain position in Carrier configuration can be the lowest frequency point, or the center frequency point, or an offset relative to the reference point. N can be used to indicate the value range of the Frequency domain position.

Method 2: the first RRC IE represents the configuration information of the second type BWP, including the second type BWP index and a bandwidth. The second RRC IE represents BWP configuration information, including a BWP index, a bandwidth and the index of the corresponding second type BWP. The third RRC IE represents carrier configuration information, including a carrier index, a frequency domain position, a bandwidth, and a corresponding BWP index list. The method can be shown with the pseudo-code that follows.

Second type BWP configuration:: = SEQUENCE {

| | |
|---|---|
| Second type BWP index | INTEGER (1..max number of second |
| | type BWP index), |

| | |
|---|---|
| Bandwidth | INTEGER (1..max number of RB), |

...
},
BWP configuration:: = SEQUENCE {

| | |
|---|---|
| BWP index | INTEGER (1..max number of BWP index), |
| Bandwidth | INTEGER (1..max number of RB), |

| | |
|---|---|
| Corresponding second type BWP index | INTEGER (1..max number |

of second type BWP index),
...
},
Carrier configuration:: = SEQUENCE {

| | |
|---|---|
| Carrier index | INTEGER (1..max number of carrier index), |
| Bandwidth | INTEGER (1..max number of RB), |

| | |
|---|---|
| Frequency domain position | INTEGER (1...N), |

| | |
|---|---|
| The corresponding BWP index list | SEQUENCE (SIZE (1..max |

number of BWP index)) OF BWP index,
...
}

Second type BWP configuration, BWP configuration, and Carrier configuration are not limited to the above. Frequency domain position in Carrier configuration can be the lowest frequency point, or the center frequency point, an offset relative to the reference point. N can be used to indicate the value range of the Frequency domain position.

Method 3: the first RRC IE represents the configuration information of the second type BWP, including the second type BWP index and a bandwidth. The second RRC IE represents BWP configuration information, including a BWP index and a bandwidth. The third RRC IE represents carrier configuration information, including a carrier index, a frequency domain position, and a bandwidth. The fourth RRC IE indicates the configuration information of the correspondence between second type BWP and BWP, including a second type BWP index and a BWP index list. This RRC IE indicates the correspondence between the second type BWP (corresponding to the second type BWP index) and the BWPs (corresponding to the BWP indexes in BWP index list). The fifth RRC IE indicates the configuration information of correspondence between BWP and carrier, including a correspondence list, which contains multiple correspondence configurations. Each correspondence configuration contains a BWP index and a carrier index. The correspondence configuration indicates the correspondence between the BWP (corresponding to the BWP index) and the carrier (corresponding to the carrier index). The method can be shown with the pseudo-code that follows.

Second type BWP configuration:: = SEQUENCE {

| | |
|---|---|
| Second type BWP index | INTEGER (1..max number of second |
| | type BWP index), |

| | |
|---|---|
| Bandwidth | INTEGER (1..max number of RB), |

...
},
BWP configuration:: = SEQUENCE {

| | |
|---|---|
| BWP index | INTEGER (1..max number of BWP index), |
| Bandwidth | INTEGER (1..max number of RB), |

...
},
Carrier configuration:: = SEQUENCE {

| | |
|---|---|
| Carrier index | INTEGER (1..max number of carrier index), |
| Bandwidth | INTEGER (1..max number of RB), |

| | |
|---|---|
| Frequency domain position | INTEGER (1...N), |

...
},
Correspondence between second type BWP and BWP
configuration:: = SEQUENCE {

| | |
|---|---|
| second type BWP index | INTEGER (1..max number of second |
| | type BWP index), |

| | |
|---|---|
| BWP index list | SEQUENCE (SIZE (1..max number of |

BWP index)) OF BWP index,
...
},
Correspondence between BWP and carrier configuration: = SEQUENCE {

| | |
|---|---|
| Correspondence list | SEQUENCE (SIZE (1..max number of |

correspondences)) OF correspondence,
Correspondence:: = SEQUENCE {

| | |
|---|---|
| BWP index | INTEGER (1..max number of BWP index), |
| Carrier index | INTEGER (1..max number of carrier index), |

...
},
...
},

Correspondence between second type BWP and BWP configuration indicates the correspondence between the second type BWP (corresponding to the second type BWP index) and the BWPs (corresponding to the BWP indexes in the BWP index list). Correspondence between BWP and carrier configuration indicates the correspondence between the BWP (corresponding to the BWP index) and the carrier (corresponding to the carrier index).

Second type BWP configuration, BWP configuration, Carrier configuration, Correspondence between second type BWP and BWP configuration, and Correspondence between BWP and carrier configuration are not limited to the above. Frequency domain position in Carrier configuration can be the lowest frequency point, or the center frequency point, or an offset relative to the reference point. N can be used to indicate the value range of the Frequency domain position.

In an example for method 1, a second type BWP with a bandwidth of 100 MHz corresponds to three BWPs, and the bandwidths of these BWPs are, respectively, 50 MHz, 30 MHz, and 20 MHz. The configuration information of the second type BWP includes the second type BWP index field configured to be 1, the bandwidth field configured to be 100 MHz, and the corresponding BWP index list field configured to be 1, 2, and 3. The indexes in the corresponding BWP index list field respectively corresponds the first BWP, the second BWP, and the third BWP.

In the example, the configuration information of the first BWP includes the BWP index field configured to be 1, the bandwidth field configured to be 50 MHz, and the corresponding carrier index field configured to be 1. The configuration information of the second BWP includes the BWP index field configured to be 2, the bandwidth field configured to be 30 MHz, and the corresponding carrier index field configured to be 2. The configuration information of the third BWP includes the BWP index field configured to 3, the bandwidth field configured to 20 MHz, and the corresponding carrier index field is configured to 3.

In the example, the carrier indexes in the corresponding carrier index fields respectively corresponds a first carrier, a second carrier, and a third carrier. The configuration information of the first carrier includes the carrier index field configured to 1 and the bandwidth field configured to 50 MHz. The configuration information of the second carrier includes the carrier index field configured to 2 and the bandwidth field configured to 30 MHz. The configuration information of the third carrier includes the carrier index field configured to 3 and the bandwidth field configured to 20 MHz.

In the example, the UE obtains the above 7 configuration information (e.g., the second type BWP, the first BWP, the second BWP, the third BWP, the first carrier, the second carrier, and the third carrier). The second type BWP 1 with a bandwidth of 100 MHz corresponds to the first BWP with a bandwidth of 50 MHz, the second BWP with a bandwidth of 30 MHz, and the third BWP with a bandwidth of 20 MHz. The first BWP corresponds to the first carrier with a bandwidth of 50 MHz, the second BWP corresponds to the second carrier with a bandwidth of 30 MHz, and the third BWP corresponds to the third carrier with a bandwidth of 20 MHz.

In some embodiments, correspondence between second type BWP and BWP is configured through RRC messages which include RRCsetup, RRCReconfiguration, ReconfigurationWithSync, or system messages. In some implementations, the system message includes SIB1. In some aspects, the system message received by UE in the IDLE state or the INACTIVE state includes the correspondence, and the RRCsetup and/or RRCReconfiguration received by UE in the connected state includes the correspondence. In some embodiments, during the handover process, the ReconfigurationWithSync received by the UE includes the correspondence. In some implementations, the correspondence between second type BWP and BWP is modified through high-layer signaling, and the high-layer signaling includes RRCReconfiguration.

In some embodiments, the configuration of the correspondence between second type BWP and BWP may be UE-specific configuration, or cell group specific configuration, or cell-specific configuration. UE-specific configuration: a correspondence is used for all cells configured by UE. Cell group specific configuration: a correspondence is used for all cells in each cell group, while the correspondences between cell groups configured by UE are configured independently. Cell-specific configuration: the correspondences between cells configured by UE are configured independently.

Step 2: referring to FIG. 5, UE configures the BWPs, the second type BWP, and the carriers. UE may configure the correspondence between second type BWP and BWP and the correspondence between BWP and carrier. The correspondence between second type BWP and BWP may include that a second type BWP corresponds to a plurality of BWPs. The bandwidth of the second type BWP may be equal to the sum of the bandwidths of a plurality of BWPs. The correspondence between BWP and carrier may include that each BWP corresponds to one carrier, or multiple BWPs correspond to multiple carriers.

A second type BWP can be mapped to a plurality of BWPs. A part of the frequency domain resources of the second type BWP can be mapped to the frequency domain resources of one BWP, and another part of the frequency domain resources is mapped to the frequency domain resources of another BWP. The second type BWP can be mapped to BWPs with the same subcarrier spacing, or can be mapped to BWPs with different subcarrier spacings.

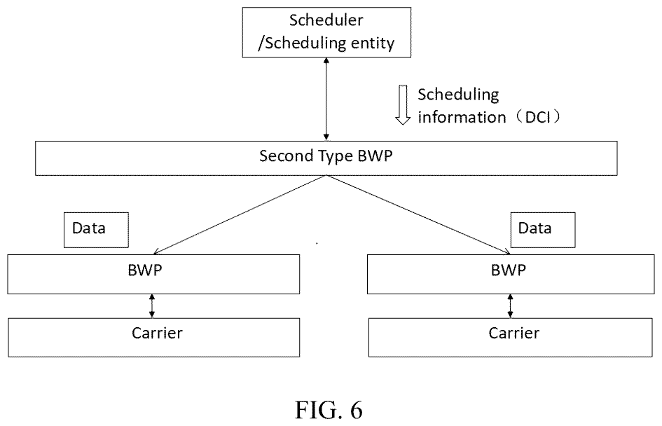

In some embodiments, UE can perform scheduling processing based on the second type BWP and the correspondence between second type BWP and BWP. In some embodiments, the second type BWP is associated with a scheduler, or a scheduling entity, or a MAC entity. The scheduling processing may include uplink scheduling and downlink scheduling. As shown in FIG. 6, the second type BWP is associated with a scheduler or a scheduling entity, and UE receives scheduling information (DCI) on the second type BWP, and receives or transmits data on the BWPs.

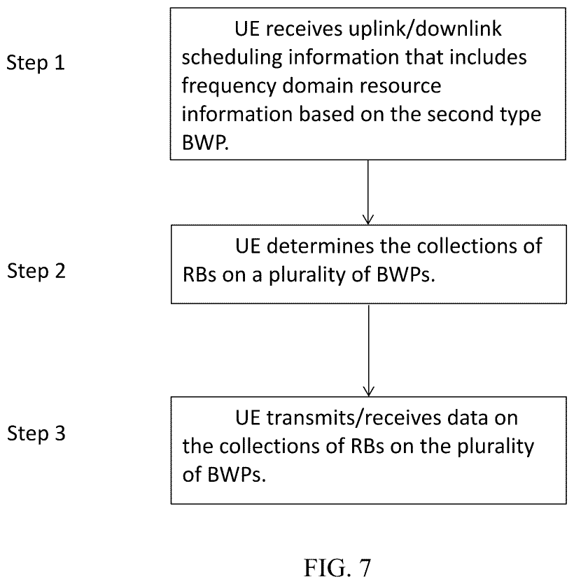

FIG. 7 is a flowchart of scheduling processing performed by UE based on second type BWP.

For uplink data transmission:

at step 1, UE may receive uplink scheduling information that includes frequency domain resource information based on the second type BWP. In some embodiments, the uplink scheduling information includes frequency domain resource information for data transmission, and the frequency domain resource information indicates the collection(s) of RBs on the second type BWP.

At step 2, UE may determine collections of RBs on a plurality of BWPs. The collections of RBs have been mapped from collections of RBs indicated on the second type BWP according to the mapping between the second type BWP and BWP.

At step 3, UE may transmit data on the collections of RBs on the plurality of BWPs. Since these BWPs correspond a plurality of carriers, it is equivalent to transmitting data on the plurality of carriers.

For example, a second type BWP 1 is mapped two BWPs, BWP1 and BWP2. The second type BWP 1 can have a bandwidth of 100 RBs. BWP1 can have a bandwidth of 50 RBs and BWP2 can have a bandwidth of 50 RBs. UE can receive uplink scheduling information, downlink control information (DCI), on the second type BWP 1. DCI can indicate 100 RBs on the second type BWP 1. The first 50 RBs on the second type BWP 1 may be mapped to the 50 RBs on the BWP1, and the other 50 RBs on the second type BWP 1 may be mapped to the 50 RBs on the BWP2. UE can determine the 50 RBs on the BWP1 and the 50 RBs on the BWP2, 100 RBs in total, to transmit data. UE can transmit data on the 50 RBs of the BWP1 and the 50 RBs of the BWP2.

For downlink data reception:

at Step 1, UE may receive downlink scheduling information that includes frequency domain resource information based on the second type BWP. In some embodiments, the downlink scheduling information includes frequency domain resource information for receiving data, and the frequency domain resource information indicates collection(s) of RBs on the second type BWP.

At Step 2, UE may determine collections of RBs on a plurality of BWPs. The collections of RBs have been mapped from collections of RBs indicated on the second type BWP according to the mapping between second type BWP and BWP.

At step 3, UE may receive data on the collections of RBs on the plurality of BWPs. Since these BWPs correspond a plurality of carriers, it is equivalent to receiving data on the plurality of carriers.

For example, a second type BWP 1 is mapped two BWPs, BWP1 and BWP2. The second type BWP 1 can have a bandwidth of 100 RBs. BWP1 can have a bandwidth of 50 RBs and BWP2 can have a bandwidth of 50 RBs. UE can receive downlink scheduling information, downlink control information (DCI), on the second type BWP 1. DCI can indicate 100 RBs on the second type BWP 1. The first 50 RBs on the second type BWP 1 may be mapped to the 50 RBs on the BWP1, and the other 50 RBs on the second type BWP 1 may be mapped to the 50 RBs on the BWP2. UE can determine the 50 RBs on the BWP1 and the 50 RBs on the BWP2, 100 RBs in total, to receive data. UE can receive data on the 50 RBs of the BWP1 and the 50 RBs of the BWP2.

A method for frequency domain resource allocation based on mapping between second type BWP and BWPs is provided, in accordance with some embodiments. In some embodiments, UE may configure mapping between second type BWP and BWPs. UE can receive scheduling information on the second type BWP, and scheduling information may include frequency domain resource allocation information. Frequency domain resource allocation information can indicate frequency domain resource allocation by indicating RB start and RB number of frequency domain resource. Resource indication value (RIV) can be used to indicate the RB start and the RB number. The RB start and the RB number can be used to represent frequency domain resource of the second type BWP. The RB start and the RB number may be more suitable for representing continuous frequency domain resource of the second type BWP. The frequency domain resource indicated on the second type BWP is mapped to frequency domain resources, collections of RBs, on the BWPs.

For example, a second type BWP 1 is mapped two BWPs, BWP1, and BWP2. The second type BWP 1 can have a bandwidth of 100 RBs, RB0 to RB99. BWP1 can have a bandwidth of 50 RBs, RB0 to RB49, and BWP2 can have a bandwidth of 50 RBs, RB0 to RB49. Frequency domain resource allocation information (RIV) can indicate that RB start is 0 and RB number is 100, meaning that the 100 RBs (RB0 to RB99) on the second type BWP 1 can be the frequency domain resource indicated by RIV. The first 50 RBs, RB0 to RB49 on the second type BWP 1 may be mapped to the frequency domain resource, RB0 to RB49 on the BWP1, and the other 50 RBs, RB50 to RB99 on the second type BWP 1 may be mapped to the frequency domain resource, RB0 to RB49 on the BWP2. For any RBx, x in RBx is RB index, and RBx stand for the (x+1)th RB.

Another method for frequency domain resource allocation based on mapping between second type BWP and BWPs is provided, in accordance with some embodiments. In some embodiments, UE may configure mapping between second type BWP and BWPs. UE can receive scheduling information on the second type BWP, and scheduling information may include frequency domain resource allocation information. Frequency domain resource allocation information can indicate Resource Block Group (RBG) allocation, wherein RBG can include one or more RBs that are continuous. The bandwidth of the second type BWP may be divided into several RBGs by RRC configuration, or standard specification predefinition. The frequency domain resource, collection of RBGs, indicated on the second type BWP can be mapped to frequency domain resources, collections of RBs, on the BWPs.

For example, a second type BWP 1 is mapped two BWPs, BWP1 and BWP2. The second type BWP 1 can have a bandwidth of 100 RBs, RB0 to RB99. BWP1 can have a bandwidth of 50 RBs, from RB0 to RB49 and BWP2 can have a bandwidth of 50 RBs, RB0 to RB49. When the RBG size is 10, the bandwidth of the second type BWP 1 can be divided into 10 RBGs, RBG0 to RBG9. Frequency domain resource allocation information can indicate 5 RBGs: RBG0, RBG2, RBG4, RBG5, and RBG7. The RBG0, RBG2, and RBG4 on the second type BWP 1 may be mapped to the frequency domain resource, RB0 to RB9, RB20 to RB29, and RB40 to RB49 on the BWP1, and the RBG5 and RBG7 on the second type BWP 1 may be mapped to the frequency domain resource, RB0 to RB9 and RB20 to RB29 on the BWP2. For any RBx, x in RBx is RB index, and RBx stand for the (x+1)th RB.

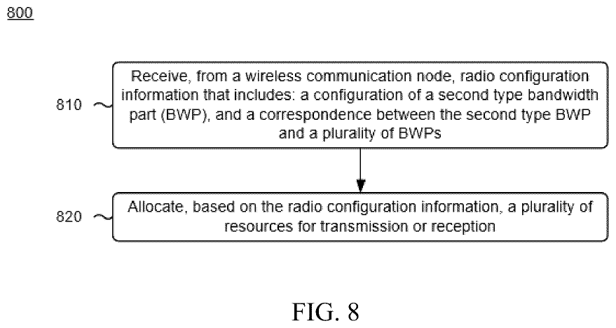

FIG. 8 illustrates a method 800 for mapping between different types of BWP, in accordance with some embodiments. Referring to FIGS. 1-7, the method 800 can be performed by a wireless communication device (e.g., a UE) and/or a wireless communication node (e.g., base station, a gNB), in some embodiments. Additional, fewer, or different operations may be performed in the method 800 depending on the embodiment.

In brief overview, in some embodiments, a wireless communication device receives, from a wireless communication node, radio configuration information that includes: a configuration of a second type bandwidth part (BWP), and a correspondence between the second type BWP and a plurality of BWPs (810). In some embodiments, the wireless communication device allocates, based on the radio configuration information, a plurality of resources for transmission or reception (820).

In more detail, at operation 810, in some embodiments, a wireless communication device receives, from a wireless communication node, radio configuration information that includes: a configuration of a second type bandwidth part (BWP), and a correspondence between the second type BWP and a plurality of BWPs. In some embodiments, the wireless communication device is a UE and the wireless communication node is a BS.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some embodiments, the wireless communication device receives scheduling information that includes frequency resource information based on the second type BWP and the wireless communication device allocates frequency resources on the plurality of BWPs for data transmission or reception.

At operation 820, in some embodiments, the wireless communication device allocates, based on the radio configuration information, a plurality of resources for transmission or reception. In some aspects, the wireless communication device allocates the plurality of resources for transmission or reception by determining, for a plurality of channels, a plurality of respective frequency-domain resources within the second type BWP, determining the plurality of frequency-domain resources within the BWPs mapped from the second type BWP, respectively, and transmitting, the plurality of channels on the plurality of BWPs, respectively. The frequency-domain resources can include one or more of resource blocks (RBs), resource units (REs), or control channel units (CCEs). The channels can include one or more of uplink channels or downlink channels.

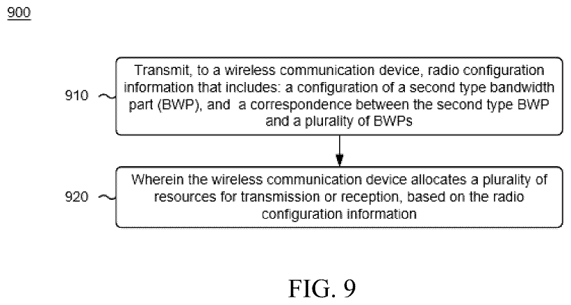

FIG. 9 illustrates a method 900 for mapping between different types of BWP, in accordance with some embodiments. Referring to FIGS. 1-7, the method 900 can be performed by a wireless communication device (e.g., a UE) and/or a wireless communication node (e.g., base station, a gNB), in some embodiments. Additional, fewer, or different operations may be performed in the method 900 depending on the embodiment.

In brief overview, in some embodiments, a wireless communication node transmits, to a wireless communication device, radio configuration information that includes: a configuration of a second type bandwidth part (BWP), and a correspondence between the second type BWP and a plurality of BWPs. In some embodiments, the wireless communication device allocates, based on the radio configuration information, a plurality of resources for transmission or reception.

In more detail, at operation 910, in some embodiments, a wireless communication node transmits, to a wireless communication device, radio configuration information that includes: a configuration of a second type bandwidth part (BWP), and a correspondence between the second type BWP and a plurality of BWPs. In some embodiments, the wireless communication device is a UE and the wireless communication node is a BS.

In some embodiments, the plurality of BWPs correspond to a plurality of carriers. In some embodiments, a first portion of the second type BWP is mapped to a first one of the plurality of BWPs, and a second portion of the second type BWP is mapped to a second one of the plurality of BWPs. In some embodiments, a bandwidth of the second type BWP is a sum of respective bandwidths of the plurality of BWPs. In some aspects, the wireless communication node transmits scheduling information that includes frequency resource information based on the second type BWP.

In some embodiments, the second type BWP is associated with a plurality of processing including at least one of: scheduling, radio resource allocation, or radio resource management.

In some embodiments, the radio configuration information indicates a correspondence between the second type BWP and a plurality of BWPs. In some implementations, the correspondence is indicated in the configuration of the second type BWP, the configuration of the plurality of BWPs, or a separate configuration independently from the configuration of the second type BWP and the configuration of the plurality of BWPs. In some aspects, the correspondence between the second type BWP and the plurality of BWPs is indicated in the radio configuration information through the method that multiple BWP indices are included in the configuration of the second type BWP. In some embodiments, the correspondence between the second type BWP and the plurality of BWPs is indicated in the radio configuration information through the method that the second type BWP index is included in the multiple BWP configurations. In some implementation, the correspondence between the second type BWP and the plurality of BWPs is indicated in a separate configuration in the radio configuration information, wherein the separate configuration includes a second type BWP index and a plurality of BWP indices.

In some embodiments, the radio configuration information includes a cell configuration that contains the second type BWP configuration, wherein the cell configuration may be similar to the configuration information indicated by ServingCellConfig 1E or ServingCellConfigCommon IE. In some implementations, the second type BWP configuration includes at least one of: a second type BWP index, a subcarrier spacing, or a bandwidth.

At operation 920, in some embodiments, the wireless communication device allocates, based on the radio configuration information, a plurality of resources for transmission or reception. In some aspects, the wireless communication device allocates the plurality of resources for transmission or reception by determining, for a plurality of channels, a plurality of respective frequency-domain resources within the second type BWP, determining the plurality of frequency-domain resources within the plurality of BWPs mapped from the second type BWP, and transmitting, the plurality of channels on the plurality of BWPs. The frequency-domain resources can include one or more of resource blocks (RBs), resource units (RE), or control channel units (CCE). The channels can include one or more of uplink channels or downlink channels.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method, comprising:
receiving, by a wireless communication device from a wireless communication node, radio configuration information that includes: a configuration of a second type bandwidth part (BWP), and a correspondence between the second type BWP and a plurality of BWPs; and
allocating, by the wireless communication device, based on the radio configuration information, a plurality of resources for transmission or reception.

2. The wireless communication method of claim 1, wherein the plurality of BWPs correspond to a plurality of carriers.

3. The wireless communication method of claim 2, wherein a first portion of the second type BWP is mapped to a first one of the plurality of BWPs, and a second portion of the second type BWP is mapped to a second one of the plurality of BWPs.

4. The wireless communication method of claim 3, wherein a bandwidth of the second type BWP is a sum of respective bandwidths of the plurality of BWPs.

5. The wireless communication method of claim 4, wherein the wireless communication device receives scheduling information that includes frequency resource information based on the second type BWP; and the wireless communication device allocates frequency resources on the plurality of BWPs for data transmission or reception.

6. A wireless communication method, comprising:
transmitting, by a wireless communication node to a wireless communication device, radio configuration information that includes: a configuration of a second type bandwidth part (BWP), and a correspondence between the second type BWP and a plurality of BWPs.

7. The wireless communication method of claim 6, wherein the plurality of BWPs correspond to a plurality of carriers.

8. The wireless communication method of claim 7, wherein a first portion of the second type BWP is mapped to a first one of the plurality of BWPs, and a second portion of the second type BWP is mapped to a second one of the plurality of BWPs.

9. The wireless communication method of claim 8, wherein a bandwidth of the second type BWP is a sum of respective bandwidths of the plurality of BWPs.

10. The wireless communication method of claim 9, wherein the wireless communication node transmits scheduling information that includes frequency resource information based on the second type BWP.

11. A wireless communication apparatus comprising at least one processor and a memory comprising instructions, wherein the at least one processor executes the instructions to:
receive, from a wireless communication node, radio configuration information that includes: a configuration of a second type bandwidth part (BWP), and a correspondence between the second type BWP and a plurality of BWPs; and
allocate, based on the radio configuration information, a plurality of resources for transmission or reception.

12. The apparatus of claim 11, wherein the plurality of BWPs correspond to a plurality of carriers.

13. The apparatus of claim 12, wherein a first portion of the second type BWP is mapped to a first one of the plurality of BWPs, and a second portion of the second type BWP is mapped to a second one of the plurality of BWPs, and wherein a bandwidth of the second type BWP is a sum of respective bandwidths of the plurality of BWPs.

14. The apparatus of claim 13, wherein the wireless communication device receives scheduling information that includes frequency resource information based on the second type BWP; and the wireless communication device allocates frequency resources on the plurality of BWPs for data transmission or reception.

15. A wireless communication apparatus comprising at least one processor and a memory comprising instructions, wherein the at least one processor executes the instructions to:
transmit, to a wireless communication device, radio configuration information that includes: a configuration of a second type bandwidth part (BWP), and a correspondence between the second type BWP and a plurality of BWPs.

16. The apparatus of claim 15, wherein the plurality of BWPs correspond to a plurality of carriers.

17. The apparatus of claim 16, wherein a first portion of the second type BWP is mapped to a first one of the plurality of BWPs, and a second portion of the second type BWP is mapped to a second one of the plurality of BWPs, and wherein a bandwidth of the second type BWP is a sum of respective bandwidths of the plurality of BWPs.

18. The apparatus of claim 17, wherein the wireless communication node transmits scheduling information that includes frequency resource information based on the second type BWP.

19. A non-transitory computer program product comprising a computer-readable program medium code stored thereupon, the code, when executed by at least one processor, causing the at least one processor to implement the method recited in claim 1.

20. A non-transitory computer program product comprising a computer-readable program medium code stored thereupon, the code, when executed by at least one processor, causing the at least one processor to implement the method recited in claim 6.
